(19) United States
(12) Patent Application Publication
(10) Pub. No.: US 2006/0106981 A1
(43) Pub. Date: May 18, 2006

(54) Method and apparatus for a self-RAID hard disk drive

(76) Inventors: Andrei Khurshudov, San Jose, CA (US); Debasis Baral, San Jose, CA (US)

Correspondence Address: GREGORY SMITH & ASSOCIATES, 3900 NEWPARK MALL ROAD, 3RD FLOOR, NEWARK, CA, 94560, US

(21) Appl. No.: 10/993,479

(22) Filed: Nov. 18, 2004

(51) Int. Cl. G06F 12/16

(52) U.S. Cl. 711/114; 711/162

(57) ABSTRACT

This invention increases reliability of hard disk drive data, continuously mirroring at least two disk surfaces in the hard disk drive. The invention includes hard disk drives implementing this method. In a hard disk drive including more than two disk surfaces, mirroring more than two disk surfaces may be preferred. The invention includes computer systems including at least one of these hard disk drives. These computers systems, include but are not limited to, notebook computers, desktop computers, servers, database engines, personal digital assistants, handheld computers, and simulation accelerators. The invention also includes removable storage systems which include at least one hard disk drive, and which may communicate via a wireline and/or wireless physical transport with a computer system.

### TECHNICAL FIELD

The invention relates to the operation of hard disk drives. More particularly, the invention relates to using multiple disk surfaces in a single hard disk drive to form a RAID (Redundant Array of Inexpensive Disks).

### BACKGROUND OF THE INVENTION

Contemporary hard disk drive users have several problems, which are not easily solved. With large disk memories, and the increasing use of hard disk drives to retain personal, technical, and business records for long periods of time, there is a growing need to extend the time over which these records can be reliably stored. The mean time between failure for a hard disk drive memory cannot be readily extended today.

In the prior art, increased reliability is achieved by using the Redundant Array of Inexpensive Disks (RAID) approach. This approach requires multiple hard disk drives, which consume power and space, cause increased heat and noise dissipation, and often require additional interface hardware to the computer system. These computer systems, by having more components, are inherently more complex, often increasing the time to install and debug them. What is needed, is a way to increase the reliability of data storage beyond what the hard disk drive mechanism can normally provide.

### SUMMARY OF THE INVENTION

The present invention includes apparatus and methods using multiple disk surfaces in a single hard disk drive to form a RAID. The invention increases the reliability of data stored in a hard disk drive, by using at least two disk surfaces to continuously mirror each other in the hard disk drive. The invention includes a method for making these hard disk drives, and the product of that manufacturing process.

Improving reliability within the hard disk drive requires two operations, mirror-writing and mirror-reading of a track. Both use at least two disk surfaces within the hard disk drive. Mirror-writing a track at a logical track location includes writing the track at the logical track location on at least two disk surfaces.

Mirror-reading the track at the logical track location starts by reading the track at the logical track location from the first disk surface. If error analysis of the track indicates the track was not successfully read, then preferably the track at the logical track location is read from the second disk surface. If the track read from the second disk surface was not successfully read, then preferably, the track image is constructed by looking at error analysis of individual sectors within the track and selecting the sector from whichever disk surface is not in error.

The invention also includes computer systems, removable storage systems, or other devices having one or more hard disk drives built in accord with the invention or using a method of the invention. Computer systems, as used herein, include but are not limited to, notebook computers, desktop computers, servers, database engines, personal digital assistants, handheld computers, and simulation accelerators. A personal digital assistant and/or handheld computer may or may not include telephone capabilities and/or Internet connection capabilities.

### BRIEF DESCRIPTION OF THE DRAWINGS

FIG. 1A shows a simplified schematic of a hard disk drive implementing the invention's method;

FIG. 1B shows the hard disk drive of FIG. 1A including more than a first disk;

FIG. 2A shows a detail flowchart of the program system of FIG. 1A in accord with the invention;

FIG. 2B shows a detail flowchart of FIG. 2A;

FIG. 3A shows a detail flowchart of FIG. 2B;

FIG. 3B shows a detail flowchart of FIG. 2B;

FIG. 4A shows a detail flowchart of FIG. 3A;

FIG. 4B shows a detail flowchart of FIG. 3B;

FIG. 5A shows a detail flowchart of FIGS. 3B and 4B;

FIG. 5B shows a detail flowchart of FIG. 5A;

FIG. 6A shows an alternative schematic view of the hard disk drive of FIGS. 1A and 1B;

FIGS. 6B and 6C show the first disk surface of FIGS. 1A and 1B;

FIG. 6D shows the second disk surface of FIGS. 1A and 1B;

FIGS. 7A to 7H show computer systems including the hard disk drive discussed in the preceding Figures;

FIG. 7I shows the computer system of FIG. 7A further including a disk-setting cable coupled to the external cable socket of FIG. 6A; and

FIG. 7J shows the invention also including a removable storage system.

### DETAILED DESCRIPTION

The present invention includes apparatus and methods using multiple disk surfaces in a single hard disk drive to form a RAID. The invention increases the reliability of data stored in a hard disk drive, by using at least two disk surfaces to continuously mirror each other in the hard disk drive. The invention includes a method for making these hard disk drives, and the product of that manufacturing process.

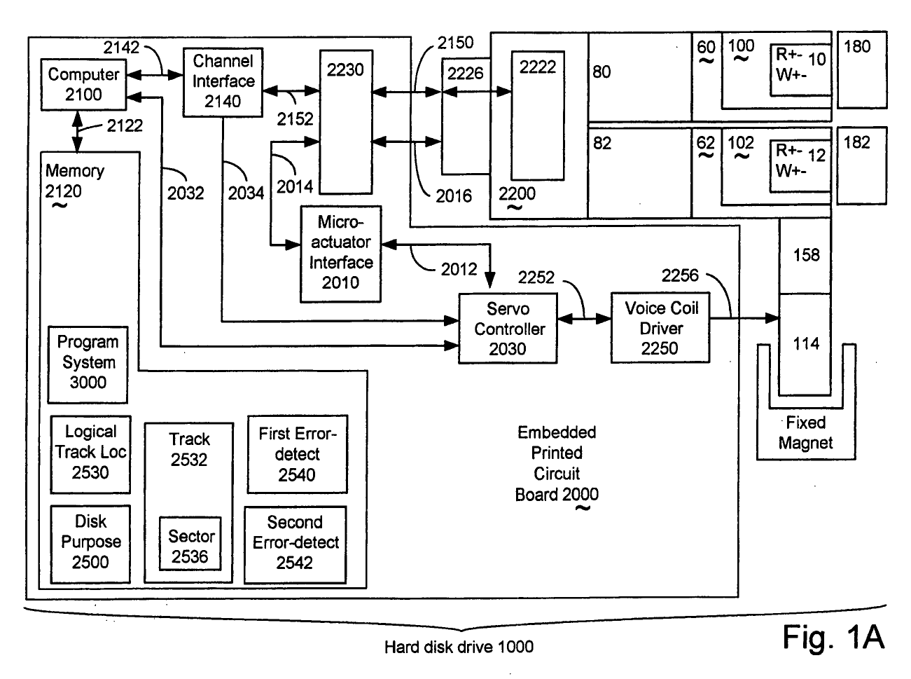

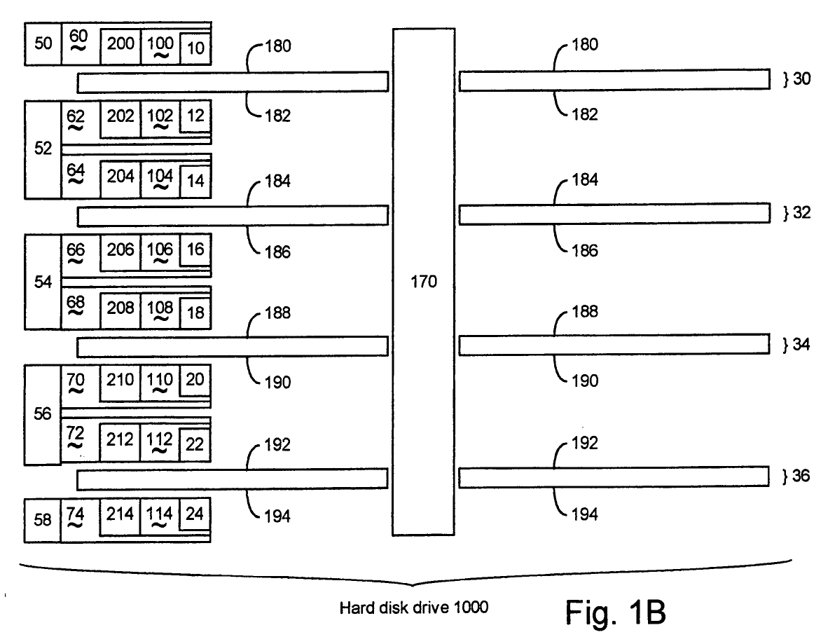

A typical simplified schematic of a hard disk drive 1000 suitable for implementing a method of the invention is shown in FIG. 1A. The hard disk drive 1000 includes an embedded printed circuit board 2000, the components of a voice coil actuator 118, and possibly a micro-actuator assembly 200, positioning the read-write head 10 over a first disk surface 180. The read-write head 10 accesses the first disk surface 180 to read and write data. The embedded printed circuit board 2000 is shown preferably including at least one computer 2100, at least one channel interface 2140, at least one micro-actuator interface 2010, a servo-controller 2030 and a voice coil driver 2250. Overall operation of the hard disk drive 1000 is typically directed by the program system 3000. The program system 3000 includes program steps residing in a memory 2120. The memory 2120 is accessibly coupled 2122 to the computer 2100.

Some of the following figures show flowcharts of at least one method of the invention, which may include arrows with reference numbers. These arrows signify a flow of control, and sometimes data, supporting various implementations of the method. These include at least one the following: a program operation, or program thread, executing upon a computer; an inferential link in an inferential engine; a state transition in a finite state machine; and/or a dominant learned response within a neural network.

The operation of starting a flowchart refers to at least one of the following. Entering a subroutine or a macro instruction sequence in a computer. Entering into a deeper node of an inferential graph. Directing a state transition in a finite state machine, possibly while pushing a return state. And triggering a collection of neurons in a neural network. The operation of starting a flowchart is denoted by an oval with the word “Start” in it.

The operation of termination in a flowchart refers to at least one or more of the following. The completion of those operations, which may result in a subroutine return, traversal of a higher node in an inferential graph, popping of a previously stored state in a finite state machine, return to dormancy of the firing neurons of the neural network. The operation of terminating a flowchart is denoted by an oval with the word “Exit” in it.

A computer as used herein will include, but is not limited to, an instruction processor. The instruction processor includes at least one instruction processing element and at least one data processing element. Each data processing element is controlled by at least one instruction processing element.

Improving reliability within the hard disk drive requires two operations, mirror-writing and mirror-reading of a track. Both use at least two disk surfaces within the hard disk drive. Mirror-writing a track at a logical track location includes writing the track at the logical track location on at least two disk surfaces.

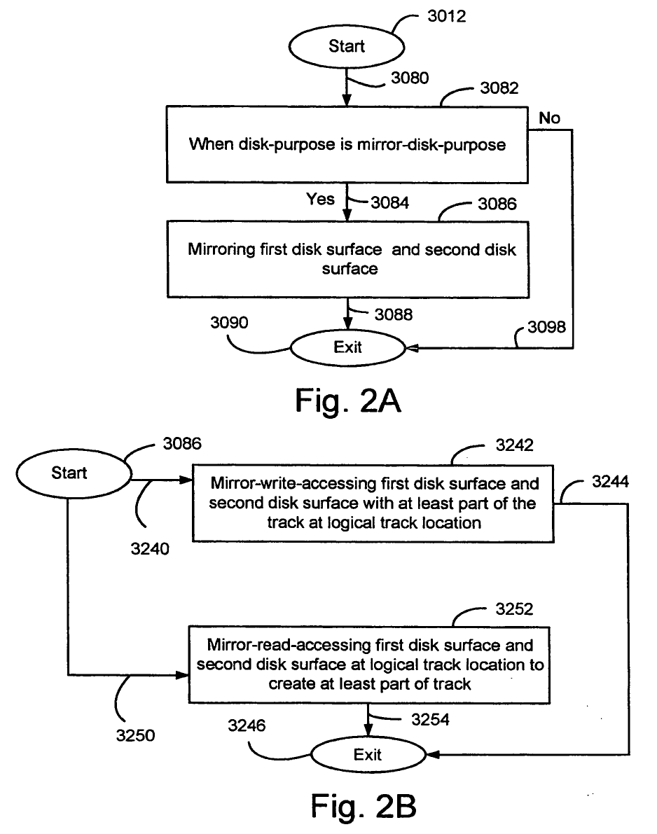

FIG. 2A shows a detail flowchart of the program system 3000 of FIG. 1A supporting mirroring the first disk surface 180 with the second disk surface 182, preferably when a disk-purpose 2500 of FIG. 1A is a mirror-disk-purpose 2510. Operation 3082 determines when the disk-purpose 2500 is the mirror-disk-purpose. When the determination 3084 is Yes, operation 3086 performs mirroring the first disk surface 180 and the second disk surface 182.

A detail flowchart of operation 3086 further mirroring the first disk surface 180 and the second disk surface 182 is shown in FIG. 2B. Operation 3242 supports mirror-writing the first disk surface 180 and the second disk surface 182 with at least part of a track 2532 at a logical track location 2530. Operation 3252 supports mirror-reading the first disk surface 180 and the second disk surface 182 at the logical track location 2530 to create at least part of the track 2532.

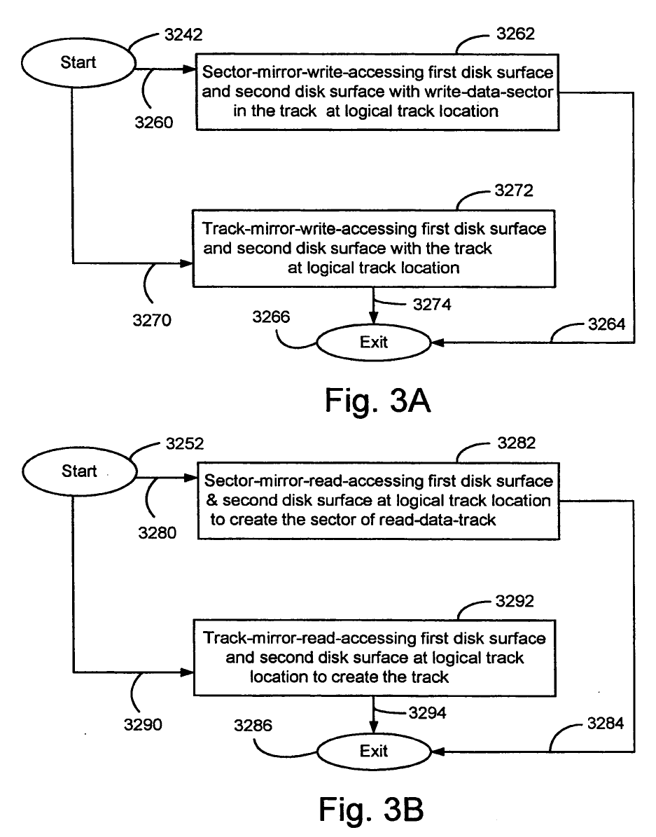

A detail flowchart of operation 3242 further mirror-writing the first disk surface 180 and the second disk surface 182 with at least part of the track 2532 at the logical track location 2530 is shown in FIG. 3A. Operation 3262 supports sector-mirror-writing the first disk surface 180 and the second disk surface 182 with a sector 2536 included in the track 2532 at the logical track location 2530. Operation 3272 supports track-mirror-writing the first disk surface 180 and the second disk surface 182 with the track 2532 at the logical track location 2530.

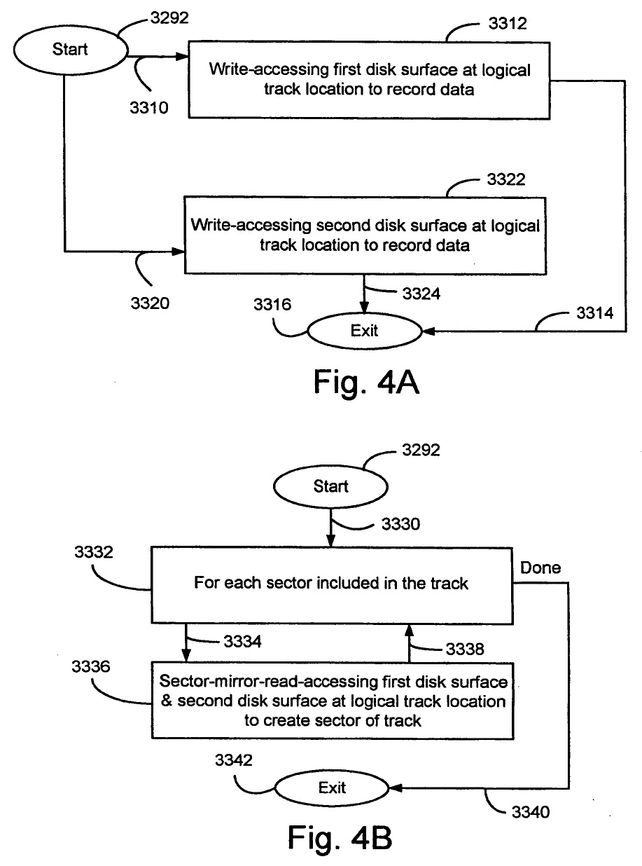

FIG. 4A shows a detail flowchart of operation 3272 further track-mirror-writing the first disk surface 180 and the second disk surface 182 with the track 2532 at the logical track location 2530 shown in FIG. 1A. Operation 3312 supports write-accessing the first disk surface 180 at the logical track location 2530 to record the track. The invention may further, preferably include operation 3322, which supports write-accessing the second disk surface 182 at the logical track location 2530 to record the track 2532.

Mirror-reading the track at the logical track location starts by reading the track at the logical track location from the first disk surface. If error analysis of the track indicates the track was not successfully read, then preferably the track at the logical track location is read from the second disk surface. If the track read from the second disk surface was not successfully read, then preferably, the track image is constructed by looking at error analysis of individual sectors within the track and selecting the sector from whichever disk surface is not in error.

FIG. 3B shows a detail flowchart of operation 3252 further mirror-reading the first disk surface 180 and the second disk surface 182 at the logical track location 2530 to create at least part of the track 2532 shown in FIG. 1A. Operation 3282 supports sector-mirror-reading the first disk surface 180 and the second disk surface 182 at the logical track location 2530 to create the sector 2536 in the track 2532. Operation 3292 supports track-mirror-reading the first disk surface 180 and the second disk surface 182 at the logical track location 2530 to create the track 2532.

A detail flowchart of operation 3292 further track-mirror-reading the first disk surface 180 and the second disk surface 182 at the logical track location 2530 is shown in FIG. 4B. Operation 3332 determines if more iterations of operation 3322 are required for each sector 2536 included in the track 2532. When the iterations are done, arrow 3340 directs the flow of execution to operation 3342, terminating the operations of this flowchart. Operation 3282, first shown in FIG. 3B, is the body of the loop, performing sector-mirror-reading the first disk surface 180 and the second disk surface 182 at the logical track location 2530 to create the sector 2536 of the track 2532.

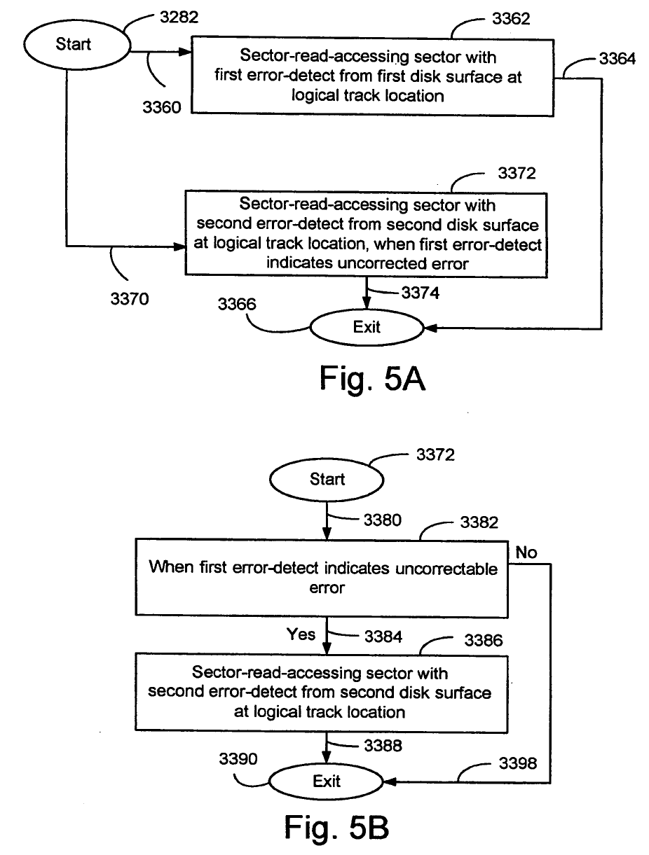

A detail flowchart of operation 3282 further sector-mirror-reading the first disk surface 180 and the second disk surface 182 shown in FIG. 5A. Operation 3362 supports sector-read-accessing the sector 2536, as shown in FIG. 1A, with a first error-detect 2540 from the first disk surface 180 at the logical track location 2530. Operation 3372 supports sector-read-accessing the sector 2536 with a second error-detect 2542 from the second disk surface 182 at the logical track location 2530, when the first error-detect 2540 indicates an uncorrectable error.

A detail flowchart of operation 3372 is shown in FIG. 5B. Operation 3382 determines when the first error-detect 2540 indicates an uncorrectable error. When the determination 3384 is Yes, operation 3386 performs sector-read-accessing the sector 2536 with a second error-detect 2542 from the second disk surface 182 at the logical track location 2530.

In the embodiment shown in FIG. 1A, the embedded printed circuit board 2000 may not include the micro-actuator interface 2010 and the first head gimbal assembly 60 may not include the micro-actuator assembly 200. When present, the micro-actuator assembly 200 may use at least one piezoelectric device and/or at least one electrostatic device.

The memory 2120 may include at least one non-volatile memory location. The memory 2120 may include at least one volatile memory location. A memory location is non-volatile when its contents are not altered when there is no power applied to the memory. A memory location is volatile when its contents may be altered when there is no power.

An alternate embodiment in FIG. 1B shows the hard disk drive 1000 including more than a first disk 30 and providing more than the first disk surface 180 and the second disk surface 182. The hard disk drive may preferably include a second disk 32, which may provide a third disk surface 184 and a fourth disk surface 186. The hard disk drive may preferably include a third disk 34, which may provide a fifth disk surface 188 and a sixth disk surface 190. The hard disk drive may preferably include a fourth disk 36, which may provide a seventh disk surface 192 and an eighth disk surface 194. The hard disk drive 1000 may include more than four disks. While this discussion will restrict itself to hard disk drives including up to four disks, aspects of the invention include more than four disks.

The first actuator arm 50 couples to the first head gimbal assembly 60 in FIG. 1B. The first head gimbal assembly 60 includes the first slider 100, shown in FIGS. 1A and 1B, which includes the read-write head 10. The read-write head 10 accesses the first disk surface 180.

Also, the second actuator arm 52 couples with the second head gimbal assembly 62 and also couples with the third head gimbal assembly 64, in FIG. 1B. The second head gimbal assembly 62 includes the second slider 102, which includes the second read-write head 12. The second read-write head 12 accesses the second disk surface 182. The third head gimbal assembly 64 includes the third slider 104, which includes the third read-write head 14. The third read-write head 14 accesses the third disk surface 184.

Also, the third actuator arm 54 couples with the fourth head gimbal assembly 66 and also couples with the fifth head gimbal assembly 68, in FIG. 1B. The fourth head gimbal assembly 66 includes the fourth slider 106, which includes the fourth read-write head 16. The fourth read-write head 16 accesses the fourth disk surface 186. The fifth head gimbal assembly 68 includes the fifth slider 108, which includes the fifth read-write head 18. The fifth read-write head 18 accesses the fifth disk surface 188.

Also, the fourth actuator arm 54 couples with the sixth head gimbal assembly 70 and also couples with the seventh head gimbal assembly 72, in FIG. 1B. The sixth head gimbal assembly 70 includes the sixth slider 110, which includes the sixth read-write head 20. The sixth read-write head 20 accesses the sixth disk surface 190. The seventh head gimbal assembly 72 includes the seventh slider 112, which includes the seventh read-write head 22. The seventh read-write head 22 accesses the seventh disk surface 192.

Also, the fifth actuator arm 58 couples with the eighth head gimbal assembly 74. The eighth head gimbal assembly 74 includes the eighth slider 114, which includes the eighth read-write head 24, in FIG. 1B. The eighth read-write head 24 accesses the eighth disk surface 194.

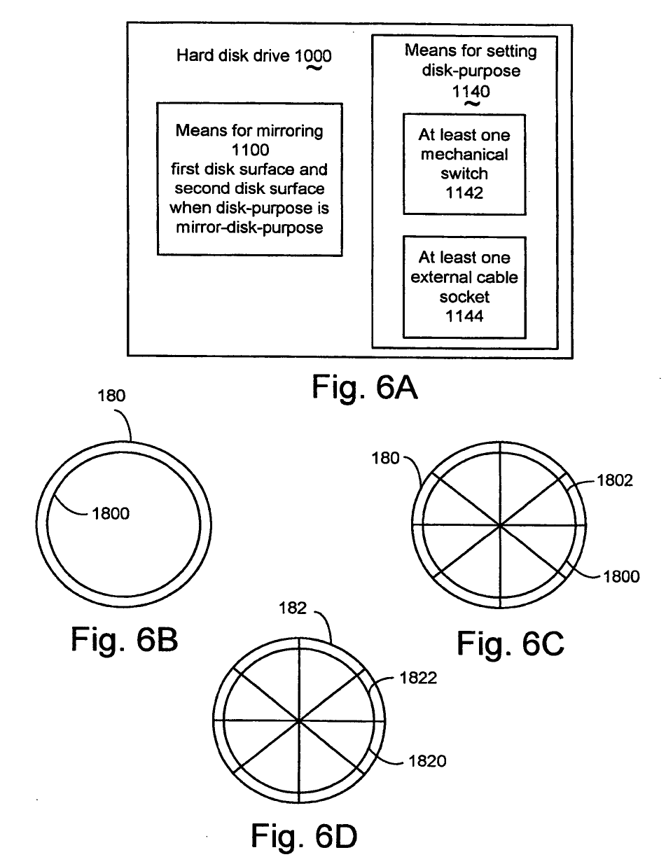

FIG. 6A shows an alternative schematic view of the hard disk drive 1000 of FIGS. 1A and 1B, including the following. A means for mirroring 1100 the first disk surface 180 and the second disk surface 182, preferably when the disk-purpose 2500 is the mirror-disk-purpose 2510.

In certain embodiments of the invention, at least one of the means of FIG. 6A includes at least one of following. A finite state machine, a computer, a program step residing in the memory 2120 accessibly coupled 2122 with the computer 2100, and a program system 3000 including at least one of the program steps.

The hard disk drive 1000 is further shown in FIG. 6A, including a means for setting 1140 the disk-purpose 2500. The means for setting 1140 may include, but is not limited to, at least one mechanical switch 1142, and/or at least one external cable socket 1144.

FIGS. 6B and 6C show the first disk surface 180 of FIGS. 1A and 1B, including a first track 1800 preferably at the logical track location 2530. In FIG. 6C, the first track 1800 includes multiple instances of a first track sector 1802.

FIG. 6D shows the second disk surface 182, including a second track 1820 also preferably at the logical track location 2530. The second track 1820 includes multiple instances of a second track sector 1822, each instance corresponding to one instance of the first track sector 1802. Typically, the first track 1800 on the first disk surface 180 will be close to, but often not the same, as the physical location of the second track 1820 on the second disk surface 182, even though both tracks are at the logical track location 2530.

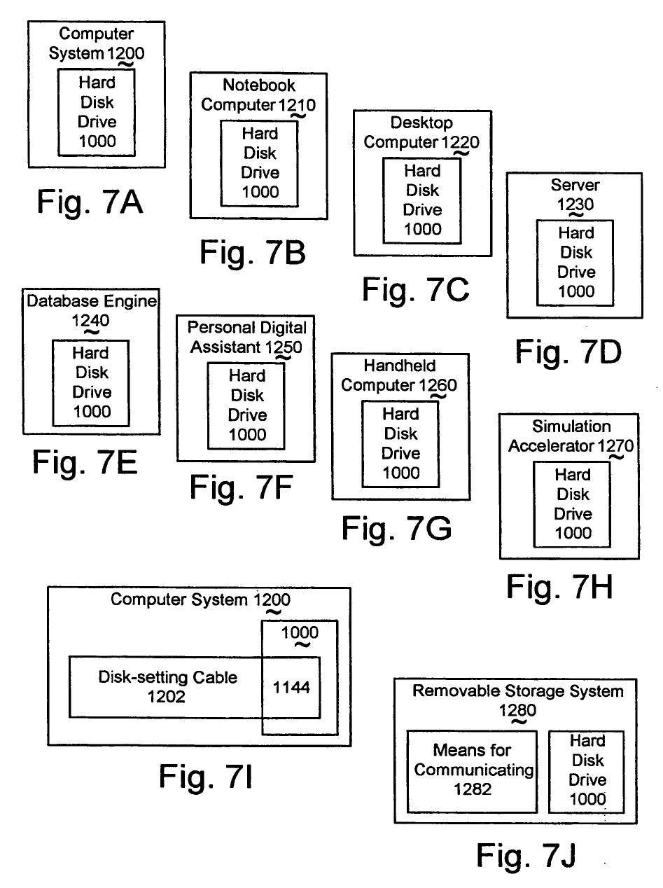

The invention includes a computer system 1200, which includes the hard disk drive 1000. FIGS. 7A to 7H show some examples of computer systems including the hard disk drive 1000 discussed in the preceding Figures. FIG. 7A shows the computer system 1200 including the hard disk drive 1000. FIG. 7B shows a notebook computer 1210 including the hard disk drive 1000. FIG. 7C shows a desktop computer 1220 including the hard disk drive 1000. FIG. 7D shows a server 1230 including the hard disk drive 1000. FIG. 7E shows a database engine 1240 including the hard disk drive 1000. FIG. 7F shows a personal digital assistant 1250 including the hard disk drive 1000. FIG. 7G shows a handheld computer 1260 including the hard disk drive 1000. FIG. 7H shows a simulation accelerator 1270 including the hard disk drive 1000. The computer system 1200 may include more than one of the hard disk drive 1000. FIG. 7I shows the computer system 1200 of FIG. 7A further including a disk-setting cable 1202 coupled to the external cable socket 1144 of FIG. 6A. The disk-setting cable 1202 is preferably used to, at least partly, set the disk-purpose 2500.

The invention also includes removable storage systems which include at least one hard disk drive, and which may communicate via a wireline and/or wireless physical transport with a computer system. Examples of a wireline physical transport include a PCMCIA interface and a USB interface. An example of a wireless physical transport includes a Bluetooth interface.

FIG. 7J shows the invention also including a removable storage system 1280, comprising at least one hard disk drive 1000. The removable storage system 1280 may further, preferably, include at least one means for communicating 1282 with a computer system via a physical transport. The physical transport may include at least one of a wireless physical transport and/or at least one wireline physical transport. The wireless physical transport may include support for a Bluetooth interface. The wireline physical transport includes support for at least one of the following: a PCMCIA interface and a USB interface.

Those skilled in the art will appreciate that various adaptations and modifications of the just-described preferred embodiments can be configured without departing from the scope and spirit of the invention. Therefore, it is to be understood that, within the scope of the appended claims, the invention may be practiced other than as specifically described herein.

What is claimed is:

1. A method of mirroring a first of a disk surface with a second of said disk surfaces, both included in a hard disk drive, comprising the steps of:
mirror-writing said first disk surface and said second disk surface with at least part of a track at a logical track location; and
mirror-reading said first disk surface and said second disk surface at said logical track location to create at least part of a track.

2. The method of claim 1,
wherein the step mirror-writing said first disk surface and said second disk surface, further comprises at least one of the steps of:
sector-mirror-writing said first disk surface and said second disk surface with a sector included in said track at said logical track location; and
track-mirror-writing said first disk surface and said second disk surface with said track at a logical track location;
wherein the step mirror-reading said first disk surface and said second disk surface, further comprises at least one of the steps of:
sector-mirror-reading said first disk surface and said second disk surface at said logical track location to create a sector of said track; and
track-mirror-reading said first disk surface and said second disk surface at said logical track location to create said track.

3. The method of claim 2,
wherein the step track-mirror-writing said first disk surface and said second disk surface with a track at said logical track location comprises the step of:
write-accessing said first disk surface at said logical track location to record said track.

4. The method of claim 3,
wherein the step track-mirror-writing said first disk surface and said second disk surface with a track at said logical track location further comprises the step of:
write-accessing said second disk surface at said logical track location to record said track.

5. The method of claim 3,
wherein the step track-mirror-reading said first disk surface and said second disk surface at said logical track location comprises, for each said sectors included said track, of the steps of:
sector-mirror-reading said first disk surface and said second disk surface at said logical track location to create said sector of said track.

6. The method of claim 3,
wherein the step sector-mirror-reading said first disk surface and said second disk surface at said logical track location to create said sector of said track further comprises the step of:
sector-read-accessing said sector with a first error-detect from said first disk surface at said logical track location; and
sector-read-accessing said sector with a second error-detect from said second disk surface at said logical track location, when said first error-detect indicates an uncorrectable error.

7. Said hard disk drive of claim 1, comprising:
means for mirroring said first disk surface and said second disk surface when said disk-purpose is said mirror-disk-purpose.

8. Said hard disk drive of claim 7, wherein said means includes at least one of: a finite state machine, a computer, a program step residing in a memory accessibly coupled with said computer, and a program system including at least one of said program steps;
wherein said computer includes at least one instruction processor and at least one data processor; wherein each said data processors is directed by at least one of said instruction processors.

9. Said hard disk drive of claim 1, comprising:
a computer accessibly coupled with a memory and directed by a program system including program steps residing in said memory;
wherein said program system comprises the program steps of:
mirror-writing said first disk surface and said second disk surface with at least part of a track at a logical track location; and
mirror-reading said first disk surface and said second disk surface at said logical track location to create at least part of a track.

10. Said hard disk drive of claim 9, wherein said memory includes at least one non-volatile memory location.

11. A computer system including at least one of said hard disk drives of claim 1.

12. The apparatus of claim 11, wherein said computer system includes at least one of a notebook computer, a desktop computer, a server, a database engine, a personal digital assistant, a handheld computer, and a simulation accelerator.

13. A method of making said hard disk drive of claim 1, comprising the step of:
installing a program system including program steps residing in a memory accessibly coupled with a computer in an embedded printed circuit board within said hard disk drive;
wherein said program system comprises the program steps of:
mirror-writing said first disk surface and said second disk surface with at least part of a track at a logical track location; and
mirror-reading said first disk surface and said second disk surface at said logical track location to create at least part of a track.

14. Said hard disk drive as a product of the process of claim 13.

15. A removable storage system including at least one of said hard disk drives of claim 1.

16. Said removable storage system of claim 15, further including at least one means for communicating with a computing system via a physical transport.

17. Said removable storage system 16, wherein said physical transport includes at least one of a wireless physical transport and a wireline physical transport.

18. Said removable storage system of claim 17, wherein said wireless physical transport includes support for a Bluetooth interface.

19. Said removable storage system of claim 17, wherein said wireline physical transport includes support for at least one of a PCMCIA interface and a Universal Serial Buss (USB) interface.
